(19) United States
(12) Patent Application Publication
(10) Pub. No.: US 2008/0005018 A1
(43) Pub. Date: Jan. 3, 2008

(54) Systems And Methods For Implementing Direct Issuer - Merchant Relationships Over A General Purpose Bankcard Network

(76) Inventor: Jonathan Robert Powell, Rye Brook, NY (US)

Correspondence Address: BAKER BOTTS L.L.P., 30 ROCKEFELLER PLAZA, 44TH FLOOR, NEW YORK, NY, 10112-4498, US

(21) Appl. No.: 11/670,869

(22) Filed: Feb. 2, 2007

Related U.S. Application Data
(60) Provisional application No. 60/764,397, filed on Feb. 2, 2006.

(51) Int. Cl. G06Q 40/00

(52) U.S. Cl. 705/39

(57) ABSTRACT

Systems and methods for implementing customized issuer-merchant relationships or programs in the payment-by-card industry are provided. The systems and methods utilize the multi-party bankcard networks common in the industry for processing card transactions, but provide direct connectivity between issuers and merchants bypassing merchant acquirers for processing card transactions covered by the customized issuer-merchant relationships.

### CROSS-REFERENCE TO RELATED APPLICATION

This application claims the benefit of United States Provisional Patent Application No. 60/764,397 filed on Feb. 2, 2006, which is hereby incorporated by reference herein in its entirety.

### BACKGROUND OF THE INVENTION

Historically, the use of “charge” cards for consumer transaction payments was at most regional and based on relationships between local credit issuing banks and various local merchants. The payment card industry has since evolved with the issuing banks forming associations (e.g., MasterCard) and involving third party transaction processing companies (e.g., “Merchant Acquirers”) to enable cardholders to widely use charge cards at any merchant's establishment, regardless of the merchant's banking relationship with the card issuer.

FIG. 6 shows an exemplary multi-party payment card industry system for enabling payment-by-card transactions in which the merchants and issuer do not need to have a one-to-one special relationship. Yet, various scenarios exist in the payment-by-card industry today, where the card issuer has a special or customized relationship with a specific merchant, or group of merchants. These special or customized relationships may, for example, include private label programs, co-brand programs, proprietary card brands, rewards programs, and others. The special or customized issuer-merchant relationships often require direct communications between the parties for transaction authorization and/or clearing (e.g., for financial transactions). Further, the issuer may be required to maintain back office processes to manage the financial aspects of these special or customized relationships. Alternatively, the issuers may exploit communications through Merchant Acquirers to facilitate indirect communications with the merchants.

Consideration is now being given to ways of improving implementations of the special or customized issuer-merchant relationships in the payment-by-card industry. In particular, attention is being directed to utilizing legacy general purpose bankcard infrastructure to support the transaction routing, merchant accounting, and financial settlement for these special or individualized relationships.

### SUMMARY OF THE INVENTION

Systems and methods for implementing special or customized issuer-merchant relationships or programs in the payment-by-card industry are provided.

The systems and methods are for implementing customized issuer-merchant relationships or programs in the payment card industry that commonly uses a general purpose bankcard network, which is linked to merchants, merchant acquirers and card issuers, for processing ordinary payment card transactions that are not covered by customized issuer-merchant relationships. The systems and methods include a registration of the customized issuer-merchant relationships or programs with the network. Processing blocks designated for specifically processing transactions covered by the registered relationships or programs are installed or merged in the network. The designated processing blocks interrogate a transaction submitted to the network to verify whether the transaction is an ordinary transaction or is a transaction covered by a registered issuer-merchant relationship and accordingly processing the transaction. Further, the designated processing blocks can flag transactions that qualify for special pricing under a registered issuer-merchant relationship or program. Additionally, the designated processing blocks calculate the differential between a pricing under a registered relationship or program and a standard pricing for a transaction, summarize transaction activity by a number of configurable variables, and move (i.e., credit or debit) funds related to transactions covered by the registered programs directly between merchant and issuer accounts bypassing the merchant acquirers.

### BRIEF DESCRIPTION OF THE DRAWINGS

Further features of the invention, its nature, and various advantages will be more apparent from the following detailed description of the preferred embodiments and the accompanying drawing in which:

FIG. 1 is a schematic diagram illustrating an exemplary solution for implementing special or customized issuer-merchant relationships in a payment-by-card system, in accordance with the principles of the present invention.

FIG. 2 is a schematic diagram illustrating authorization request process flows in the exemplary solution of FIG. 1, in accordance with the principles of the present invention.

FIG. 3 is a schematic diagram illustrating clearing process flows in the exemplary solution of FIG. 1, in accordance with the principles of the present invention.

FIG. 4 is a schematic diagram illustrating settlement flows in the exemplary solution of FIG. 1, in accordance with the principles of the present invention.

FIG. 5 is a schematic diagram illustrating chargeback and adjustment flows in the exemplary solution of FIG. 1, in accordance with the principles of the present invention.

FIG. 6 is a schematic diagram illustrating an exemplary multi-party payment card industry system for enabling ordinary payment-by-card transactions in which the merchants and issuer do not need to have a one-to-one special relationship.

### DESCRIPTION OF THE INVENTION

Systems and methods for implementing special or customized issuer-merchant relationships in the payment-by-card industry are provided.

For convenience in description herein, the inventive systems and methods are collectively referred to as “solutions” herein. Further, a special or customized issuer-merchant relationship may be referred to herein interchangeably as the “program.”

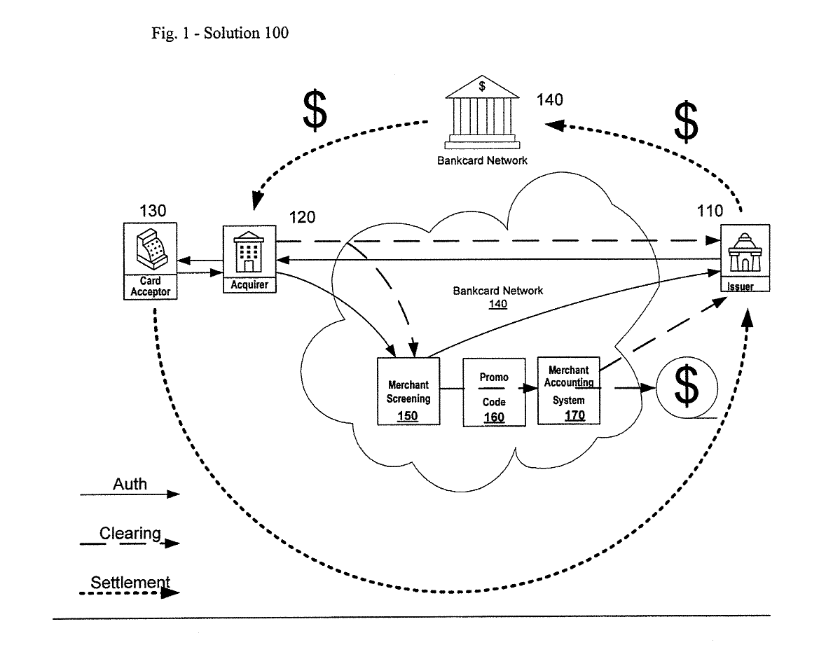

An inventive solution 100 (FIG. 1) exploits legacy payment-by-card industry infrastructure for implementing a special or customized issuer-merchant relationship. The legacy payment-by-card industry infrastructure includes traditional payment networks (e.g., general purpose bankcard payment network 140), which links entities such as the card issuer or bank (e.g., Issuer 110), card acceptors (e.g., Merchants 130), and third-party transaction processors (e.g., Merchant Acquirers 120). Solution 100 incorporates one or more specific processing blocks (e.g., Merchant Screening Block 150, Promotion Code Processing Block 160, and Merchant Accounting System Block 170) for processing special relationship transactions in payment network 140.

In practice, an issuer who has a special relationship or program with specific merchants registers the program with the payment network 140 for tracking card transactions and associating features (e.g., benefits such as special pricing) of the program with the card transactions. Card transaction data (“transactions”) from various merchant sites 130 may be collected in a conventional manner, for example, by Merchant Acquirer 120 or other traditional entities who then submit the transaction to network 140 for forwarding to Issuer 10. The transactions may be formatted in a conventional manner (e.g., according to any suitable payment industry standards used on network 140).

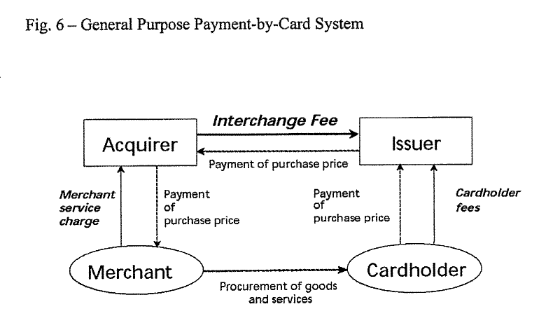

In solution 100, after a transaction is submitted to network 140, the transaction is interrogated to determine if the transacting merchant (e.g., 130) and Issuer 110 have a relationship that corresponds to a registered program, which covers the transaction. At Merchant Screening Block 150, the transaction is validated as covered or, conversely, designated as not covered by a registered program. The validation may involve the use of suitable algorithms to apply a specific set of criteria which define the relationship or program. The specific set of criteria may, for example, include transaction parameters such as the merchant type and identity, the cardholder identity, the nature of the transacted goods or services, and the location, time and dollar value of the transaction. Next, at Promotion Code Processing Block 160, the validated transaction may be flagged if it qualifies for special pricing under the registered program. For the case where the transaction qualifies for special pricing, Merchant Accounting System Block 170 is configured to calculate the differential between the special pricing for the specific transaction under the program and the standard pricing of a normal bankcard transaction (i.e., which is not covered by the program). Merchant Accounting System Block 170 is further configured summarize transaction activity by a number of configurable variables, to report adjustments to the Issuer's interchange, to generate payment files to credit or debit merchants' accounts on behalf of the Issuer for the differential, and to provide miscellaneous reports to both the Issuer and merchants to facilitate reconcilement. In solution 100, the settlement procedures between Acquirer 120 and Issuer 110 may be the same or similar to those used in conventional payment card schemes (FIG. 6).

From the issuer's perspective in the context of implementing special relationships, solution 100 advantageously eliminates the need to establish connectivity directly with merchants (and/or one or more Acquirers) to implement the special relationships. Further, solution 100 reduces back office processing requirements on the issuer. Solution 100 also allows the issuer to independently manage the special relationships with the merchants without third party (e.g., an Acquirer) involvement. The issuer can, for example, independently manage proprietary pricing structures directly with merchants without having to go through an Acquirer. Further, solution 100 allows the issuer to offer pricing plans that are not transaction-based. Solution 100 lets the issuer to use the same payment network infrastructure to process chargebacks and make adjustments directly with merchants, and to establish rewards programs with specific merchants without requiring any special setup at merchant locations.

From the merchants' perspective, solution 100 provides special relationship processing, which is transparent to merchants' acquirers. Further, solution 100 improves settlement as transactions associated with the special relationship are settled through the general purpose bankcard process instead of ad hoc systems specific to the special relationships. Merchants also may expect improved pricing from issuers due to infrastructure efficiencies in solution 100. Solution 100 also advantageously provides merchants with the ability to offer reward program incentives to improve sales.

From the merchant acquirers' perspective, solution 100 advantageously allows transparent passthrough of the special relationship related processing without imposing any specific coding or setup requirements related to the special relationships on the acquirers. Yet, solution 100 advantageously increases bankcard transaction volume by including the special relationship transactions in the acquirers' settlement with issuers.

Conventional card transition data processing involves clearing, authorization, chargebacks and adjustments, settlements, and other front or back end processes. During the clearing process, the acquirer provides the appropriate issuer data required to identify the cardholder's account and the dollar amount of the sales. When the issuing bank gets this data, the bank posts the amount of the sale as a draw against the cardholder's available credit and prepares to send payment to the acquirer. Authorization involves the acknowledgment by the issuer that a particular account may be charged for the amount of the sale. In the settlement process, the issuer sends a record of money that is being transferred from its account to that of the acquirer, who then pays the merchant. Funds are settled between issuers and acquirers through selected bank accounts. Chargebacks and adjustments processes relate to a card transaction that is billed back to the merchant after the sale has been settled.

The authorization, clearing, chargebacks and adjustments, and settlements processes for card transactions in solution 100 are further described in more detail herein with reference to FIGS. 2-5, respectively.

FIG. 2 shows the authorization process flows in solution 100. The authorization requests may have the same format as standard general purpose bankcard authorization requests. The flow of these authorization requests from merchant 130 via acquirer 120 to network 140 can utilize existing flow paths established for ordinary card transactions, Then, network 140 routes the authorization requests to Merchant Screening Block 150 for verification that the requesting merchants are included in a registered program.

Merchant Screening Block 150 may be configured to process the authorization requests, for example, to optionally cross-reference merchant IDs, authorize, decline, or pass on the request to Issuer 110 systems for further processing. In some implementations of solution 100, Merchant Screening Block 150 may be further configured to route a specific card number transaction to different issuer systems depending on specific criteria met by the transaction (e.g., merchant number, dollar amount, etc.). In the case of non-financial rewards transactions, Merchant Screening Block 150 may be configured to capture and store transactions for later submission into a nightly clearing process.

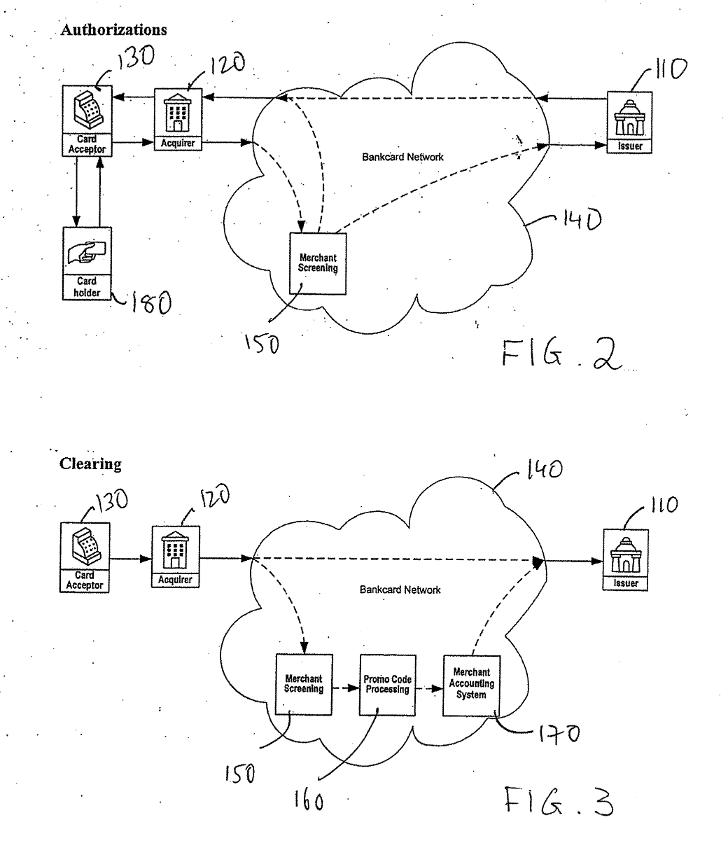

The clearing process flows in solution 100 can be understood with renewed reference to FIG. 3. The card transaction data (i.e., clearing records) may have the same format as standard general purpose bankcard clearing records. Like the flow of the authorization requests, the flow of these records from merchant 130 via acquirer 120 to network 140 can utilize existing flow paths and standard interchange rates established for ordinary card transactions (i.e., non-special relationship transactions). Network 140 may route the clearing records to Merchant Screening process block 150 as part of nightly clearing to include the appropriate cross referencing merchant identifications (IDs), and to flag records from merchants not included in the registered programs. Optionally, the merchant screening process may be a secondary process performed outside of the clearing process.

Network 140 then routes the clearing records to Promotion Code Processing Block 160 to generate the appropriate codes under registered programs so that the appropriate discount differentials can be calculated for the merchants covered by the programs. Next, Network 140 routes the clearing records to the Merchant Accounting System Block 170 to calculate the discount differential for individual clearing records. The discount differential may be based on any number of configurable variables. For example, the discount differential may be based on discount rates, which may be listed in merchant account records available on the network, and on the promotion codes, if any. Further, in the case of a rewards program, Merchant Accounting System Block 170 may be configured to calculate the fees to be charged to the merchant for participation in the rewards program.

Next in the clearing process, Merchant Accounting System Block 170 forwards the clearing records to Issuer 110, records transactions and summarizes them by a number of configurable variables to debit or credit differential to merchant accounts, and provides reporting to the merchants and Issuer 110.

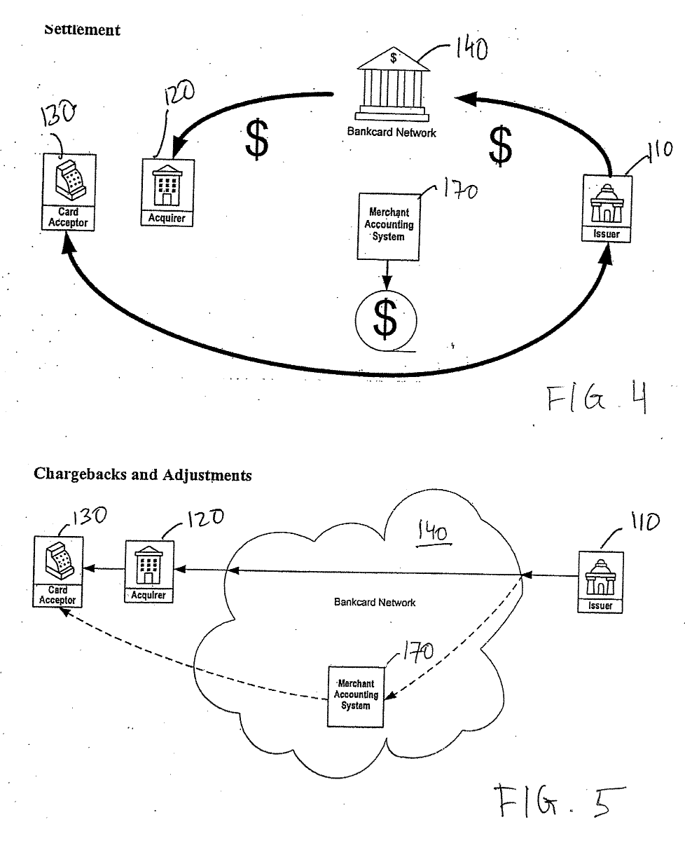

FIG. 4 shows the settlement process flows in solution 100. Bankcard Network 140 settles funds with Acquirer 120 using standard interchange rates and settlement processes. Similarly, Issuer 110 settles funds with bankcard Network 140 using standard interchange rates and settlement processes. It is noted that in solution 100, Merchant Accounting System Block 170 can create payment files to move debit/credit funds directly between the merchants' and Issuer's accounts for the differential amounts or the fees involved in rewards programs or other programs.

Lastly, FIG. 5 shows the chargebacks and adjustments process flows in solution 100. In solution 100, chargebacks and adjustments that conform to standard bankcard policies are processed through existing flow paths with Issuer 110 submitting records through the bankcard network 140 to Acquirers 120. Similarly, Acquirers 120 utilize existing process flow paths back to merchants 130 for chargebacks and adjustments that conform to standard bankcard policies.

However, as shown in FIG. 5, chargebacks and adjustments that have unique properties because of the special relationship between the Issuer 110 and merchants 130 are processed through Merchant Accounting System Block 170. Such chargebacks are processed directly between Issuer 110 and merchants 130. The chargebacks can be for an entire amount of the transaction, or strictly for the portion of the chargeback that exceeds standard bankcard policies, as appropriate under specific programs. Similarly, adjustments for any of the special programs are processed directly with the merchant accounts in the same manner, and can be included in the summarized transaction activity used to credit/debit funds and provide reporting.

While there have been described what are believed to be the preferred embodiments of the present invention, those skilled in the art will recognize that further changes and modifications may be made thereto without departing from the spirit of the invention, and it is intended to claim all such changes and modifications that are within the spirit of the invention. For example, in FIGS. 1-5 and the related description Merchant Screening Block 150, Promotion Code Processing Block 160 and Merchant Accounting Systems 170 are shown as separate blocks or units. However, it is readily understood that the structure and functions of these blocks can be easily merged in a single block or partitioned into further blocks.

It also will be understood that the systems and methods of the present invention can be implemented using any suitable combination of hardware and software. The software (i.e., instructions) for implementing and operating the aforementioned systems and methods can be provided on computer-readable media, which can include without limitation, firmware, memory, storage devices, micro controllers, microprocessors, integrated circuits, ASICS, on-line downloadable media, and other available media.

1. A system for implementing customized issuer-merchant relationships or programs in the payment card industry that uses a general purpose bankcard network, which is linked to merchants, merchant acquirers and card issuers, for processing ordinary payment card transactions that are not covered by a customized issuer-merchant relationships, the system comprising:
a registration of the customized issuer-merchant relationships or programs; and
a merchant screening block installed in the general purpose bankcard network, wherein the merchant screening block is configured to interrogate a transaction submitted to the network the verify whether the transaction is an ordinary transaction or is a transaction covered by a registered issuer-merchant relationship and accordingly processing the transaction.

2. The system of claim 1, further comprising a promotion code processing block installed in the general purpose bankcard network, wherein the promotion code processing block is configured to flag transactions that qualify for special pricing under a registered issuer-merchant relationship or program.

3. The system of claim 1, further comprising a merchant accounting system block installed in the general purpose bankcard network, wherein the merchant accounting system block is configured to calculate the differential between a pricing under a registered relationship or program and a standard pricing for a transaction.

4. The system of claim 1, further comprising a merchant accounting system block installed in the general purpose bankcard network, wherein the merchant accounting system block is configured to summarize transaction data thru configurable methods, provide reporting, and credit or debit funds between merchant and issuer accounts directly bypassing the merchant acquirers.

5. The system of claim 1, further comprising a merchant accounting system block installed in the general purpose bankcard network, wherein the merchant accounting system block is configured to process chargebacks and adjustments for a transaction covered by a registered issuer-merchant relationship directly between merchant and issuer accounts directly bypassing the merchant acquirers.

6. A method for implementing customized issuer-merchant relationships or programs in the payment card industry that uses a general purpose bankcard network, which is linked to merchants, merchant acquirers and card issuers, for processing ordinary payment card transactions that are not covered by a customized issuer-merchant relationships, the method comprising:
registering the customized issuer-merchant relationships or programs with the general purpose bankcard network; and
interrogating a transaction submitted to the general purpose bankcard network to verify whether the transaction is an ordinary transaction or is a transaction covered by a registered issuer-merchant relationship and accordingly processing the transaction.

7. The method of claim 6, further comprising flagging transactions submitted to the general purpose bankcard network that qualify for special pricing under a registered issuer-merchant relationship or program.

8. The method of claim 6, further comprising calculating the differential between a pricing under a registered relationship or program and a standard pricing for a transaction submitted to the general purpose bankcard network.

9. The method of claim 6, further comprising summarizing transaction data thru configurable methods, providing reporting, and crediting or debiting funds for transactions covered by registered issuer-merchant relationships between merchant and issuer accounts directly bypassing the merchant acquirers.

10. The method of claim 6, further comprising processing chargebacks and adjustments for a transaction covered by a registered issuer-merchant relationship directly between merchant and issuer accounts directly bypassing the merchant acquirers.

11. Computer-readable media for implementing customized issuer-merchant relationships or programs in the payment card industry that uses a general purpose bankcard network, which is linked to merchants, merchant acquirers and card issuers, for processing ordinary payment card transactions that are not covered by a customized issuer-merchant relationship, the computer-readable media comprising executable instructions for:
registering the customized issuer-merchant relationships or programs with the general purpose bankcard network; and
interrogating a transaction submitted to the general purpose bankcard network to verify whether the transaction is an ordinary transaction or is a transaction covered by a registered issuer-merchant relationship and accordingly processing the transaction.

12. The computer-readable media of claim 11, further comprising executable instructions for flagging transactions submitted to the general purpose bankcard network that qualify for special pricing under a registered issuer-merchant relationship or program.

13. The computer-readable media of claim 11, further comprising executable instructions for calculating the differential between a pricing under a registered relationship or program and a standard pricing for a transaction submitted to the general purpose bankcard network.

14. The computer-readable media of claim 11, further comprising executable instructions for summarizing transaction data thru configurable methods, providing reporting, and crediting or debiting funds for transactions covered by registered issuer-merchant relationships between merchant and issuer accounts directly bypassing the merchant acquirers.

15. The computer-readable media of claim 11, further comprising executable instructions for processing chargebacks and adjustments for a transaction covered by a registered issuer-merchant relationship directly between merchant and issuer accounts directly bypassing the merchant acquirers.
